(19) United States
(12) Patent Application Publication
(10) Pub. No.: US 2001/0020228 A1
(43) Pub. Date: Sep. 6, 2001

(54) Umethod, system and program for managing relationships among entities to exchange encryption keys for use in providing access and authorization to resources

(75) Inventors: Arthur Cantu, San Diego, CA (US); Henry Martin Gladney, Saratoga, CA (US)

Correspondence Address: David W. Victor, KONRAD RAYNES & VICTOR LLP, Suite 210, 315 S. Beverly Drive, Beverly Hills, CA, 90212, US

(73) Assignee: International Business Machines Corporation

(21) Appl. No.: 09/814,624

(22) Filed: Mar. 22, 2001

Related U.S. Application Data
(63) Continuation-in-part of application No. 09/349,171, filed on Jul. 9, 1999.

(51) Int. Cl. G06F 17/60; H04L 9/00

(52) U.S. Cl. 705/1; 380/278

(57) ABSTRACT

Provided is a method, system, and program for managing access to resources. Encryption keys are exchanged among a first entity, second entity, third entity, and a fourth entity. Each entity has one relationship with one other entity and the encryption keys are exchanged pursuant to the relationships. Electronic messages are encrypted with the encryption keys concerning digital enrollments to provide to the first entity. The digital enrollment is associated with at least one digital ticket that authorizes access to a resource managed by the fourth entity. Presentation of the digital enrollment causes the presentation of one digital ticket associated with the digital enrollment to authorize the first entity to access the resource.

### RELATED APPLICATIONS

This application is a continuation-in-part of the commonly assigned patent and co-pending patent application entitled “Method, System, and Program for Managing Access and Authorization to Resources”, to H. M. Gladney, having U.S. application Ser. No. 09/349,171 and filed on Jul. 9, 1999, which application is incorporated herein by reference in its entirety.

### BACKGROUND OF THE INVENTION

1. Field of the Invention

The present invention relates to a method, system, and program for using relationships among entities to exchange encryption keys for use in providing access and authorization to resources.

2. Description of the Related Art

Current secured electronic transactions, including on-line Internet transactions, typically involve a service organization, such as a bank, entertainment content provider, etc., providing goods and services to customers through some authentication system managed and operated by the service organization. Typically, the service organization assigns the consumer a password, which the consumer submits to the service organization to authenticate himself and authorize access to goods and services. To provide additional security, the transmission of information between the consumer and service organizations may be encrypted. This is referred to as password based credentials. Further details on the definition of the terminology used for electronic transactions is described in the publication of the International Standards Organization, entitled “Information technology—Open Systems Interconnection—Systems management: Objects and attributes for access control,” ISO/I EC DIS 10164-9, ISO/IEC JTC 1, 1995, which publication is incorporated herein by reference.

In other systems, the user's rights to access resources is determined after the user's identity is authenticated. Authentication refers to the process of corroborating the identity of an entity, such as a person, computer terminal, credit card, etc. Authentication includes the process of establishing with known confidence that a token passing between processes in fact represents what it purports to represent. A token identifies the subject or originator of the process and includes a secret message or code that could only come from the single user authorized to use this subject. If the token is acceptable, then the subject is bound to the issuing processes. For instance this process of token authorization is referred to as “login” or “logon” if the subject is a person. In security systems, authentication is distinct from authorization, which is the process of providing users access to system objects if doing so conforms to the policy of the object owners. Authentication verifies the identity of the user requesting access, but does not determine whether the requester has the privilege and responsibility to utilize or control the resource.

Systems often include an access control management security component that determines permitted uses of resources within an open system environment and that prevents unauthorized access, i.e., authentication and authorization. An access control policy provides the set of rules that define the conditions under which an access may occur.

Cross-organizational authentication and access control refers to a situation where an institution “A” agrees to share limited access to resources with other institutions, pursuant to a licensing agreement or other arrangement. An institution, such as a library, school, corporation, may provide access to resources, such as a digital library, to a user community. This community can be large, and membership may be volatile over time. Further, different members of the community may have different access rights to the network resources. Membership in and access to the resources granted to the user community may be managed by another institution “B” that has reached an agreement with the resource operator institution “A” that members of the user community have certain levels of access to the network resource.

Those working on cross-organizational access management have identified a need to develop models and solutions to access management problems in this area. See, “A White Paper on Authentication and Access Management Issues in Cross-Organizational Use of Networked Information Resources,” by Clifford Lynch, published on the Internet at www.cni.org/projects/authrentication/authentication-wp.html (April, 1998). Access management solutions in this area would substantially facilitate both licensing and resource sharing between institutions.

Any solution to a cross-organizational access method should satisfy the following criteria. An access management system should be easy to deploy and operate, minimize redundant authentication interactions, and be the most efficient mechanism among potential alternatives. Systems should be scalable to allow the easy addition or removal of licensing institutions, as well as new levels of access to the network resources. Furthermore, the software and hardware that end users need to access the shared resource should be available in common products, such as commonly available web browsers, etc. Furthermore, the institution “B” and its managers of resource servers should be able to change both the resources and the rules of access to any resource without knowing who the users are; similarly, the institution “A” should be able to change the membership in user communities that it manages without having to communicate this to (any agent of) the serving institution B.” Furthermore, the solution should be reasonably secure and have authentication strength commensurate with the resource being managed.

Often shared resources, such as a digital library and other network resources, require a fine grained access control to the resource, such as numerous different levels of access. Providing fine grained access can be especially cumbersome, since each licensing institution defining a user community may provide numerous levels of access. One problem with a password based credential system is that the resource operator would have to maintain a list of user IDs and passwords and levels of access for each user. Such a mapping of passwords to different allowed resources could be quite cumbersome, especially as modifications are made to access privileges for entire communities of users. In many cases it may be impractical to attempt to maintain user lists to use to determine whether to authorize access because the user list may be dynamic and constantly changing. This is the case with membership in large organizations, such as a university, consumer organization (e.g., Automobile Association), political party, etc.

It is also important to incorporate privacy concerns into the management access system. Privacy is the ability of an individual or organization to control whether, when and to whom personal or organizational information is released, and to limit the circumstances in which a subject or process can intrude into some control domain. The licensing institution may have a set of internal policies that promise and guarantee the privacy of its community of users. However, the resource provider may have a different set of policies and could possibly use the identity of users to gather information for various marketing purposes or sell such access information and the identity of users. One problem with a password based credential system is that the user IDs and passwords would have to be transferred to the resource operator, which could undermine the privacy of the users. Privacy is a major concern of consumers, especially consumers who want to access a resource anonymously. Consumers are especially concerned that providing their identity to access a resource may allow others to compile information on their identity and products they purchase, and sell such information to other parties, such as telemarketers or other companies that want to direct advertise to the customers. In fact, privacy is one of the most publicized issues concerning Internet electronic transactions, and the subject of legislation and advocacy groups whose sole purpose is consumer privacy.

A still further consideration in designing a system for cross-organizational access management involves a methodology to determine the identity of the entities involved transmitting messages to provide access to the resource. One prior art technique for identifying a user is the use of a certificate authority that issues a certified public key to a person asserting an identity. The certificate authority certifies that the identity is bound to that public key. Other parties can then communicate information to another entity involved in the access scheme using the public key assigned by the certificate authority. One problem with the use of certificate authorities is their inability to verify the identity of the person requesting and registering a public key to be bound to the asserted identity. Certificate authorities issue millions of public keys a year at a low fee, e.g., five to ten dollars. This cost structure does not allow the certificate authorities to accurately verify that the applicant requesting the certification of an association of a public key and a particular identity is the actual identity. In other words, the certificate authority is not an authority on what the certificate certifies.

There is thus a need in the art for a methodology for participants in a cross-organizational access scheme to provide encryption keys for use in managing access to shared resources.

### SUMMARY OF THE PREFERRED EMBODIMENTS

Provided is a method, system, and program for managing access to resources. Encryption keys are exchanged among a first entity, second entity, third entity, and a fourth entity. Each entity has one relationship with one other entity and the encryption keys are exchanged pursuant to the relationships. Electronic messages are encrypted with the encryption keys concerning digital enrollments to provide to the first entity. The digital enrollment is associated with at least one digital ticket that authorizes access to a resource managed by the fourth entity. Presentation of the digital enrollment causes the presentation of one digital ticket associated with the digital enrollment to authorize the first entity to access the resource.

In further implementations, the first entity and the second entity have a first relationship such that the first entity is associated with the second entity and the second entity and third entity have a second relationship through which entities associated with the second entity can access resources managed by the fourth entity.

Still further, the third entity and fourth entity may have a third relationship through which the fourth entity makes managed resources available to entities designated by the third entity.

Yet further, the exchange of the encryption keys may further comprise exchanging the encryption keys with a fifth entity. In such case, the fifth entity maintains a mapping of digital enrollment to associated digital tickets. The first entity uses the encryption key of the fifth entity received during the exchange of encryption keys to encrypt a message including the digital enrollment to transmit to the fifth entity. The fifth entity uses the first entity encryption key received during the exchange of encryption keys to decrypt the message received from the first entity providing the digital enrollment. The mapping is processed to determine the digital tickets associated with the received enrollment. The fifth entity uses the first entity encryption key received during the exchange of encryption keys to encrypt a message including the digital tickets to transmit to the first entity to use to access the resource from the fourth entity.

The described implementations provides a technique for using preexisting relationships among entities to exchange public keys of the entities. The entities can be assured as to the authenticity of the binding of the public keys to the entity identities pursuant to relationships the entities have with each other, such that the degree of authenticity is commensurate with the nature of the relationship of the entities. The described implementations further provide a technique for using the encryption keys exchanged pursuant to the relationship to allow the first entity to access resources managed by the fourth entity when there is no convenient common authority for all the four entities.

### BRIEF DESCRIPTION OF THE DRAWINGS

Referring now to the drawings in which like reference numbers represent corresponding parts throughout:

FIG. 1 is a model of a transaction when there is a common authority;

FIG. 2 illustrates a model in accordance with preferred embodiments when there is no common authority in the transaction;

FIG. 3 illustrates an arrangement of entities involved in a resource access system in accordance with preferred embodiments of the present invention;

FIG. 4 illustrates logic for different entities to implement to facilitate a user's access of a resource in accordance with preferred embodiments of the present invention;

FIGS. 5a and 5b illustrate an additional embodiment for facilitating user access to a resource in accordance with preferred embodiments of the present invention; and

FIGS. 6a and 6b illustrate a yet further embodiment for facilitating user access to a resource in accordance with preferred embodiments of the present invention.

FIG. 7. illustrates the relationship of entities involved in a resource access system; and

FIG. 8 illustrates a methodology for the entities described in FIG. 7 to exchange public keys pursuant to preexisting relationships among the entities.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

### Models for Accessing Resource

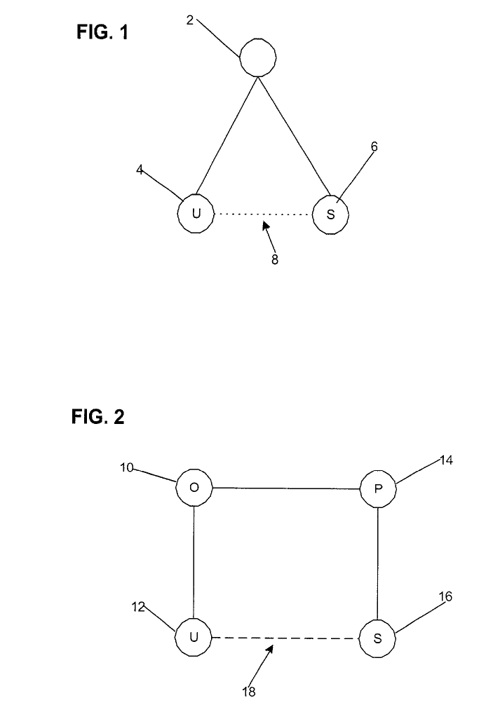

FIGS. 1 and 2 illustrate different models for how a user (U) may access a resource (R) managed by a server (S). The resource may be a network resource, such as a software program, information in digital format, or other digital content in any format, including text, sound files (e.g., music), video files (e.g., movies, news reports, etc.). Alternatively, the resource R may be a tangible product that is later delivered to the user (U) via mail, etc. Further, the resource may comprise an active resource, such as a machine the user desires to operate, e.g., an automobile, heavy machinery, home appliance, military weaponry, etc.

FIG. 1 models the transaction where there is a common authority 2 between a user (U) 4 and server (S) 6 that provides access to a resource desired by the user (U) 4. For instance, the common authority 2 may be a bank where the user (U) 4 is a customer and the server 6 may be some service providing aspect offered by the bank, such as brokerage services or on-line banking. The common authority 2 would provide the user (U) 4 a certificate which the user (U) 4 presents to authenticate the user identity in communications. The certificate comprises an unforgeable object, i.e., proof, that attests to the accuracy, correctness, completeness, and provenance of some information, which in the model of FIG. 1 is the identity of the user (U) 4. The server (S) 6 upon receiving the certificate from the user (U) 4 can be assured with a reasonable level of certainty that the identity of the entity sending the communication is user (U) 4.

For instance, in the public/private key encryption scheme, a common authority 2 provides a public key to the server (S) 6 and a private key to the user (U) 4. The server (S) 6 can be assured as to the validity of the public key because the common authority 2 is the source. This allows the server (S) 6 with reasonable certainty to authenticate the identity of the entity sending the communication because the server (S) 6 is assured by the common authority 2 that only the actual entity could encrypt the message with the private key such that the public key is able to decrypt the message. Upon authenticating the identity of the user (U) 4, the server (S) 6 may then determine the privileges associated with the user and determine whether the user (U) 4 is entitled to the requested resource.

The model in FIG. 1 is premised on the assumption that there is a common authority 2 between the user (U) 4 and server (S) 6 which both parties in the transaction utilize to obtain authorization and access. Further, whenever the user (U) 4 wants to engage the server (S) 6 for a resource R, the user (U) 4 must first obtain the proper authorization from the common authority 2. The dotted line 8 illustrates the transaction, and the solid line between the common authority 2 and U 4 and S 6 illustrate certification transactions that must occur to provide the user (U) 4 and server (S) 6 with the information needed to transact. However, in many transactions there is no common authority 2 between the user (U) 4 and server (S) 6, or the only common authorities are either inconveniently remote or decline to provide the functionality described in the prior paragraph, i.e., no convenient common authority. This situation of no convenient common authority is illustrated in FIG. 2.

FIG. 2 illustrates a consuming organization (O) 10 of which the user (U) 12 is a member. The user (U) 12 enters into an agreement with the consuming organization (O) 10 to become a member of one or more privileged classes, i.e., to enroll in one or more classes. Likewise, the service organization (P) 14 manages and controls one or more servers (S) 16. The service organization (P) 14 may be a consortium that manages certain operations of the servers 16. Alternatively, the service organization (P) 14 may be the owner of multiple servers S 16. In either case, the service organization (P) 14 and consuming organization (O) 10 enter into an agreement where each server (S) 16 of the producing organization 14 will provide member users 12 of the consuming organization access to a set of resources, wherein the services accorded to one such user might be different than those authorized to some other users. The dotted line 18 represents a transaction between the user (U) 12 and server (S) 16 that occurs after the following conditions are satisfied: the user (U) 12 has entered into a membership agreement with the consuming organization (O) 10 to receive certain resource sets (which, when the subsequent agreements are in effect, include resource R in S); the service organization (P) 14 has entered into an agreement with the server (S) 16 to provide R to any user who can cause a suitable ticket to be presented; and the service organization (P) 14 and consuming organization (O) 10 have entered into an agreement associating certain enrollments with certain tickets. These three conditions have the cumulative effect of providing that the service organization's (P) 14 servers (S) 10 provide certain resources to users 12 associated with the consuming organization (O) 10 in the appropriate membership classes (also known as enrollments or enrollment classes).

The FIG. 2 model embodiment applies to many situations. For instance, two entities may negotiate through authorized agents, such as attorneys, agents, personal representatives, etc. In such case, the parties, e.g., the user (U) 12 and the server (S) 16, interact at the transaction level to perform transactions on behalf of their respective principals. In this case, there is no convenient common authority between the server (S) 16 and user (U) 12. Nonetheless, both the server (S) 16 and user's (U) 12 authorities have previously agreed to allow the server (S) 16 and user (U) 12 to engage in transactions on their behalf.

The model illustrated in FIG. 2 would also apply to the cross-organizational use of networked information resources described in the Lynch article incorporated by reference above. In this application of FIG. 2, the consuming organization (O) 10 would be the licensing institution that enters into an agreement to provide certain network resources to a community of users 12. The service organization (P) 14 is the institution that manages servers 20 that provide access to the network resources. In such case, the consuming organization (O) 10 enters into an agreement with the service organization (P) 14 under which the users 10 that are members of the consuming organization (O) 10 are allowed to access certain predetermined resources managed by the servers 16. The server (S) 16 and user (U) 12 then engage in transactions without any common authority therebetween providing certificates or authorization. Moreover, in the models of both FIGS. 1 and 2, interspersed in the transaction paths may be any number of intermediate authorities or agents that act on behalf of the different entities. For instance, in FIG. 2, there could be intermediaries for O 10 and P 14 between the arc joining O 10 and P 14. For an intermediary to “speak for” a principal, the intermediary must have the appropriate authentication to perform operations on behalf of a principal.

### Systems for Managing Access when there is no Convenient Common Authority

In the situation, illustrated in FIG. 2, where there is no convenient common authority, the parties engaging in the transaction, i.e., the user and server, want to complete a transaction with minimal interactions with their respective authorities or other intermediaries to minimize transaction costs. Further, the user often desires to maintain privacy in the transaction and provide as little identification information as possible. Further, the parties often want to reduce the likelihood of fraud. Both the user and the server might want to prevent unauthorized or even fraudulent interactions by third parties. Further both the user and the server might want to eliminate or reduce the risk of inappropriate transaction repudiation when the server responds to the user.

In the current art, access management systems are designed in accordance with two basic assumptions. One is that two parties need a common point of authority to provide access and the second is that the identity of the user requesting access must be presented. However, to provide access, the identity of the user is not needed. Instead, the user requesting access must present sufficient credentials to allow the server to authorize access to the resource, which does not necessarily have to include the identity of the user. The server only needs to know the pertinent user access rights and privileges reliably, not the user identity. In the context of security, reliability refers to the state where a request or transaction conforms to the security and integrity objects either stated explicitly or impliedly by the discussion context. For instance, a message communicated reliably is a message whose originator is truly the individual that the receiver supposes sent the message, was correctly understood by the recipient, whose content was precisely what the originator intended, and which arrived in time for the shared purposes of the originator and recipient.

Preferred embodiments provide access management methods that do not conform to either of the above common assumptions, replacing them with assumptions that are less revealing and much easier (or less expensive) as a bases for action in a digital communication and processing network. With preferred embodiments, the user need not present identity information to authenticate access. Moreover, there need not be a common authority. The preferred systems thus increase consumer privacy by not allowing the server (S) to view or record the identity of the user (U). Further, by eliminating the need of a common authority, the system avoids the need to locate or assign a common authority, thereby avoiding additional layers of intermediaries to process the transaction. Eliminating intermediaries further reduces potential points of access to information to perpetrate fraud.

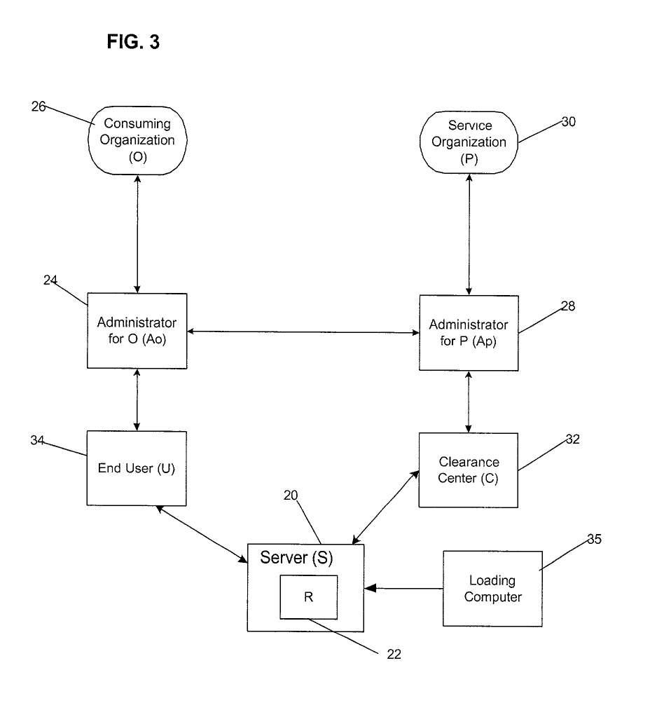

FIG. 3 illustrates a system in which preferred access management schemes are implemented. Server (S) 20 holds resources (R) 22. Resources 22 may be passive, e.g., data sets, or active, e.g., programs which may be executed. Further, the resources 22 may be the combination of such programs connected by well-known means to any kind of machinery, such as computer controlled machine tools, weapon systems, home appliances, etc. The server (S) 20 may comprise any computer system known in the art for serving information or processing requests for access to data or programs managed by the server. Alternatively, the server (S) 20 may be an outlet or center that provides goods or services. The information, data, programs, goods or services that the server (S) 20 controls are the resources (R) 22. The server (S) 20 preferably maintains an access control list (not shown) that includes mappings of users or groups of users to a set of privileges within R. The access control list may be included in access and authentication programs known in the art, such as the International Business Machines Corporation (IBM) RACF security server.** Alternatively, if the server (S) 20 is a low level machine, such as a computer embedded inconspicuously in an appliance, then the access control list may be maintained by an additional computer controlled by some Administrator (Aₛ) 24 of the service organization (S) 30, also shown as loading computer 35 in FIG. 3 that loads programs and data into the server (S) 20. ** RACF and DB2 are registered trademarks of IBM, Java is a trademark of Sun Microsystems Corporation.

Aₚ 28 is the agent or administrator for the producer organization P 28. A clearance center (C) 32 maintains a map of enrollments (E) to tickets (T) for each server (S) 20 the clearance center (C) 32 supports. An enrollment (E) is a declaration of membership in a subset of the set of members of an organization. An enrollment may comprise a token linking a particular user to a organization and group within the organization. For instance, the enrollment (E) could bind a user id to an organization id and specific user community id within the organization. An enrollment (E) is useful only when held by a user (U) 34 and the right of the user (U) 34 to use the enrollment is verified. An enrollment (E) may be associated with an expiration time stamp users 34 cannot modify. Further, users 34 may have a view of this expiration time stamp to determine when new tickets (t) must be obtained.

A ticket (t) is a physical token, digital message portion, or digital data control block which allows certain privileges to the individual or process that holds the ticket. The user (U) 34 would present the ticket (t) to access a resources (R) 22. A ticket (t) is useful only when a user (U) 34 presents the ticket (t) to the server (S) 20, and then only if the ticket (t) is valid for the service. Preferably, such a ticket (t) would be obtained by the server (S) 20 forwarding the user presented enrollment (e) to the clearance center (C) 32 which determines whether the enrollment (e) entitles the user (U) 34 to the benefits of ticket (t) as if the user (U) 34 presented the tickets (t). Further, ticket (t) validity may depend on ticket modifiers, which are conditions that must be verified before the ticket may be used. For instance, the ticket (t) may be valid only at certain times or there may be an expiration time for the ticket (t). Further, there may be a counter limiting the number of times the ticket (t) may be used to grant access to a resource.

Such modifiers may also limit the time duration of enrollments, and the mappings of tickets to resources, users to enrollments, and enrollments to tickets. In such case, the consuming organization (O) 26 would determine the validity of the user enrollment mapping from the modifier before presenting the user the enrollments. The server (S) 20 would determine the validity of the resource to ticket mapping based on any modifiers when determining whether a ticket authorizes access to a resource, and the clearance center may determine the validity of the enrollment to ticket mapping based on any modifiers before transmitting tickets in response to receiving an enrollment

The server (S) 20 may maintain an access control list including a mapping of user IDS to resources. When providing a mapping of tickets to resources, the server (S) 20 may utilize current access control list data structures by adding rows in the access control list of tickets mapping to resources. In this way, the server (S) 20 would permit access to a resource upon being presented with a user id or ticket that maps to the resource in the access control list.

The clearance center (C) 32 further maintains a list of all principals, such as Aₚ 28, from whom it will accept information, such as tickets (t), and enrollments and mappings of enrollments to tickets. The clearance center (C) 32 may represent multiple servers 20. The set of servers 20 supported by a clearance center (C) 32 use the same ticket value for equivalent resources (R) 22. The representation of a ticket (t) is preferably a token unique among all tickets for a clearance center (C) 32 or domain, and may be a character string.

The administrator Aₒ 24 for a consuming organization (O) 26 maintains enrollments which map users into sets of members for access granting purposes. Each user (U) 34 stores enrollments (E) requested and received from Aₒ.

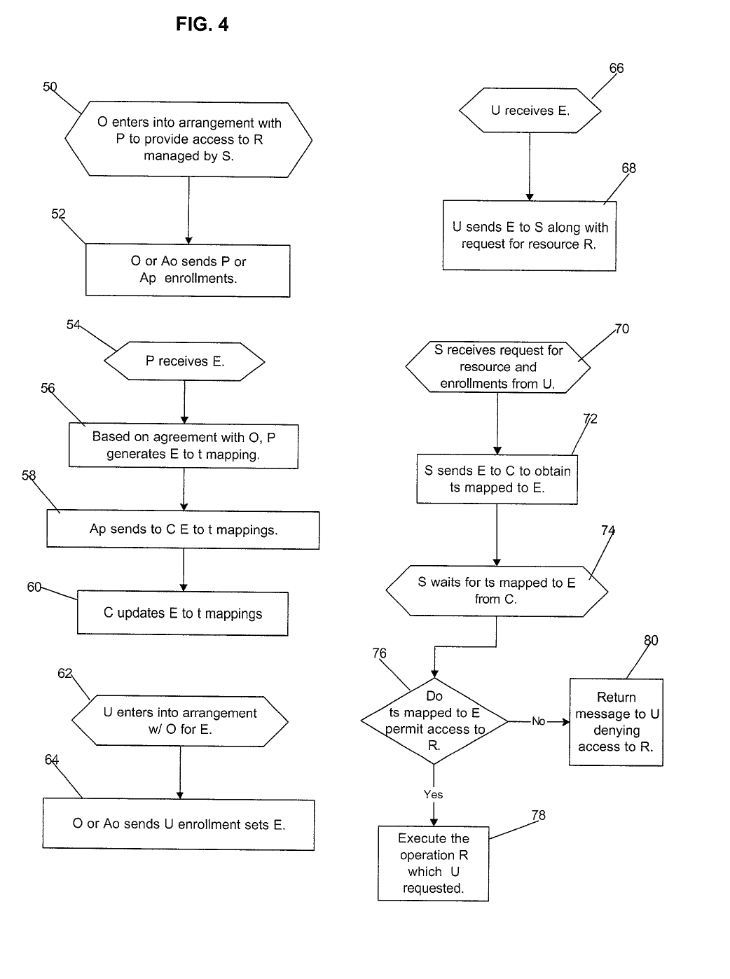

FIG. 4 illustrates a flow of operations in the systems illustrated in FIG. 3 to control access to a resources (R) 22. Each actor, i.e., S 20, A_{o 24}, O 26, Aₚ 28, P 20, and C 32, include protocol software to transmit messages to perform the steps in FIG. 4 and application software to perform the operations and protocol processing required to implement the access and authentication scheme of the preferred embodiments. For instance, the user (U) 34 protocols may be implemented in an Internet Web browser which the user (U) 34 uses to interface with the server (S) 20, which would include an HTTP server and the protocol software of the preferred embodiments to process a request for a resource. The server (S) 20, consuming organization (O) 26, service organization (P) 30, and clearance center (C) 32 may include a database program, such as the IBM DB2** database product, to maintain mappings of user IDS to enrollments (e), enrollments (e) to tickets, and tickets to resources. The protocol may be implemented in the JAVA** language with messages in Extended Mark-up Language (XML). ** RACF and DB2 are registered trademarks of IBM, Java is a trademark of Sun Microsystems Corporation.

The process begins (at block 50) with the consumer organization 26 entering into an agreement with the service organization (P) 30, where the service organization (P) 30 will provide user communities of the consuming organization (O) 26 with different levels of access to resources (R) 22 controlled by servers 20, over which the serving organization P 30 has authority. The consuming organization (O) 26 or its agent Aₒ 24 would provide (at block 52) the service organization (P) 30 or its agent Aₚ 28 with information on its enrollments E. Upon receiving the enrollments (E) (at block 54), the service organization (P) 30 would generate (at block 56) a mapping of enrollments (E) to tickets (t) that provide access to resources (R) 22 based on the agreement with the consuming organization (O) 26. The service organization (P) 30 or its agent 28 would then send (at block 58) the mappings of enrollments (E) to tickets (t) to the clearance center (C) 32. The clearance center (C) 32 then updates (at block 60) its enrollment (E) to ticket (t) mappings.

Asynchronously, user (U) 34 enters into an agreement (at block 62) with the consuming organization (O) 26 for enrollments (E) that will provide the user (U) 34 access to certain resources (R) 22. In response, the consuming organization (O) 26 or its agent Aₒ 24 sends (at block 64) the user (U) 34 the user enrollments (E). A user may have multiple enrollments. After receiving the user enrollments (E) (at block 66), the user (U) 34 may send (at block 68) the user enrollments (E) to the server (S) 20 and information on a requested resources (R) 22 to access. In response, to receiving the request for the resources (R) 22 and user enrollments E (at block 70) from the user (U) 34, the server (S) 20 would send (at block 72) the enrollments (E) to the clearing house 32 to obtain tickets t for the enrollments (E) level. Upon receiving the tickets (t) for the enrollment (E) (at block 74), the server (S) 20 would determine (at block 76) whether the tickets t associated with the user enrollments permit access to the requested resources (R) 22. If the tickets (t) associated with the enrollment (E) permit access, then the server (S) 20 executes (at block 78) the operation R which the user (U) 34 requested; otherwise, access is denied (at block 80). This enrollment (E) to tickets (t) mapping reflects the service agreement, and may contain any limitations on the use of the ticket, such as an expiration date. Further, limitations other than a time stamp may be provided, such as a maximum number of uses of the ticket (t) to access the resource (R).

In alternative embodiments, the user (U) 34 may send the enrolments (E) directly to the clearance center 30 to obtain the tickets (t) for the enrollment. In such case, the user (U) 34 would send the tickets (t) and resources (R) 22 request to the server (S) 20. The server (S) 20 would maintain an access control list of ticket (t) to resource mappings to determine whether to grant the user (U) 34 access. Alternatively, the server (S) 20 may maintain the tickets, and mappings among tickets, enrollments (E), and resources (R) 22 to determine whether to grant or deny access to the requested resource. In such case, updates to the map in the server (S) 20 would be made frequently.

The system of FIGS. 3 and 4 provides access without requiring a common authority between the user (U) 34 and the server (S) 20. Further, the user (U) 34 need only provide the server (S) 20 with an enrollment (E) certificate, which specified a level of enrollment for the user (U) 34 with the consuming organization O 26. This allows users to remain anonymous because an id need not be presented. Still further, the system is fully scalable as resources can be added or removed by adding, removing or modifying the tickets associated with the resources. Further, user additions or deletions or modifications to access rights can be easily modified by changing the mapping of enrollment to tickets to alter the rights provided by a user's enrollment or by providing the user with a different enrollment level. This allows the consuming organization to readily modify the access rights for members of its user community.

Moreover, with preferred embodiments, users can be easily added to the system by providing user enrollments. This means that users can access resources without disclosing their identity as all they must present is an enrollment, which the consuming organization provides. The enrollment may include time stamp modifiers that limit their use and require updates from the consuming organization to continue access. This insures that the users are the current set of users.

### Encrypted Embodiments

In further implementations, each message communicated as part of the operations outlined in FIG. 4 may be encrypted to protect against fraud, prevent eavesdropping, and further protect privacy. In preferred embodiments, it is a goal to provide that each entity, e.g., O, P, Aₚ, Aₒ, S, and U, is provided at each step with the minimal amount of information needed to perform its step in the overall process. By minimizing what each entity, receives, the opportunity for any actor to misuse information is minimized.

Preferred embodiments utilize the public key cryptography standards. There are two keys, a public key and private key, and either can encrypt or decrypt data. A user maintains a private key and distributes public keys to others. The user can then encrypt messages with the private key and send to others having the public key. The recipients may use their public key to decrypt the message from the holder of the private key or use the public key to encrypt a message to send to the holder of the corresponding private key to decrypt. A public key algorithm is the algorithm used for encrypting and decrypting data with the public and private keys. Public key algorithms include the Rivest, Shamir, and Adleman (RSA) algorithm, or may include any public key encryption algorithm known in the art, such as Diffie and Hellman. Further details of public key encryption is described in the publication “An Overview of the PKCS Standards,” RSA Laboratories Technical Note, by Burton S. Kaliski, Jr. (1993) and “Handbook of Applied Cryptography,” by Alfred J. Menezes, Paul C. van Oorschot, and Scott A. Vanstone (1996), which publications are incorporated herein by reference in their entirety.

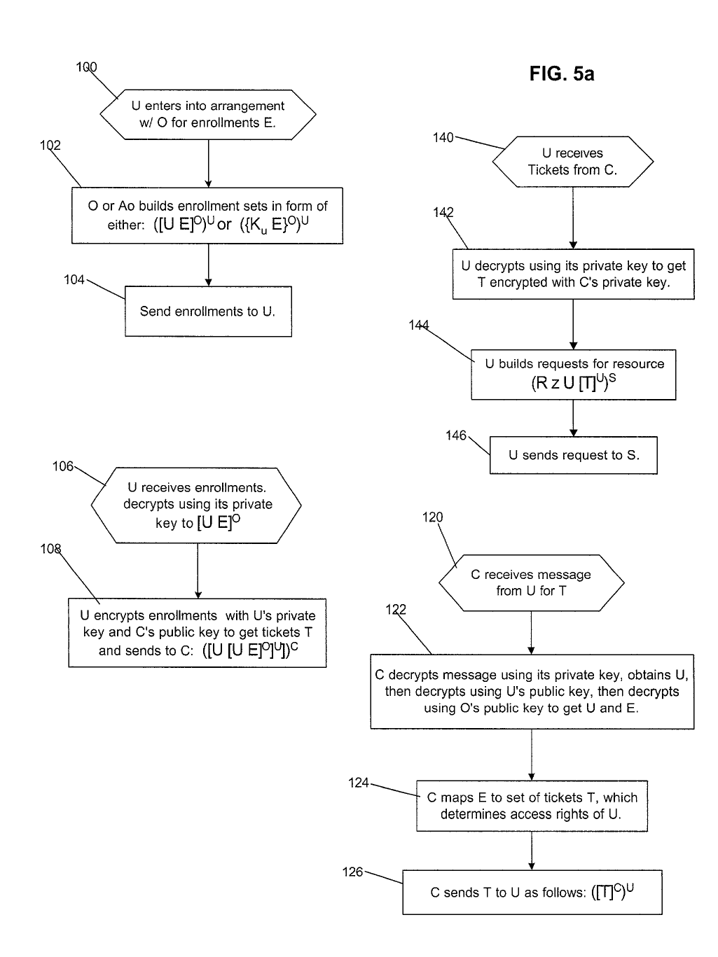

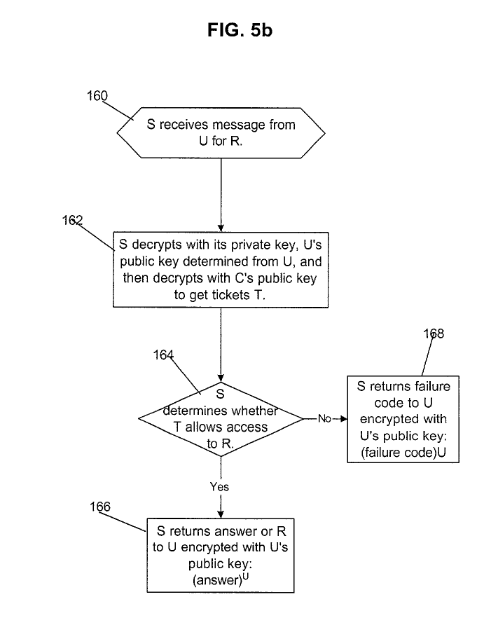

FIGS. 5a, b illustrate embodiments of the protocols described with respect to FIG. 4 with encryption added. In the preferred encrypted embodiments, the sender of a message encrypts the message with the recipient's public key to provide confidentiality and provide the recipient with assurance that the message is indeed intended for the recipient. Further, the sender may encrypt the message with the sender's private key, which the recipient decrypts with the sender's public key, to assure the recipient of the identity of the sender. The following notation are used to describe the encrypted embodiment:

K_{Y}/J_{Y}—upper case K and J are the public and private keys, respectively of Y.

[x]^{Y}—the brackets indicate that the content X within the brackets is encrypted with the private key J_{Y} of Y, the superscript;

(X)^{Y}—the parentheses indicate that the content X within the parentheses is encrypted with the public key K_{Y} of Y;

e—is an enrollment and E is a set of enrollments e;

t—is a ticket and T is a set of tickets;

kᵤ/jᵤ—is an anonymity pair for a user (U). If the user does not want to reveal the user identity U during transactions, the user may represent its identity U as an ephemeral public/private key pair. Both the user and the consuming organization (O) of which U is a member will know the association of the identity of the user, i.e., U, with the anonymity key pair kᵤ/jᵤ. Use of the encrypted anonymity key pair further enhances the user's privacy by not using any identity attributes of the user during a transaction. Instead, a random encrypted anonymity key pair is used to identify the user. {X}^{Y}—the braces indicate that the content X within the brackets are signed using a private anonymity key of Y k_{y}/j_{y}. This anonymity key pair generates both the private and public key.

FIGS. 5a, b illustrate an access and authorization scheme in which the user (U) 34 obtains tickets (t) providing access to specific resources (R) 22 from the clearance center (C) 32, and then submits the tickets (t) to the server (S) 20 to access the resources (R) 22. The operations in FIG. 4 concerning the agreement between the consuming organization (O) 26 and the user (U) 34 and the serving organization 30, at blocks 50-62, would remain relatively unchanged, except that the parties could use the public/private key encryption scheme to encrypt the messages. Further, the clearance center (C) 32 would maintain the public key of O (K_{O}) which it could obtain from the service organization (P) 30 or its agent Aₚ 28, which would have received the public key of the consuming organization (O) 26 directly. After the user (U) 34 enters into an agreement with the consuming organization (O) 26 (at block 100), the consuming agent 26 or its agent Aₒ 24 would then send the user (U) 34 (at block 102) enrollment sets (E) as shown in one of the two forms (1) and (2) below:

([U E]^{O})^{U} (1)

or {[kᵤ E]^{O}}^{U} (2)

To send the user (U) 34 the enrollments (E) using format (1), the consuming organization (O) 26 or its agent 24 encrypt the enrollments (E) and user identity information twice, first using the private key of the consuming organization (O) 26 (J_{O}) and, second, the public key (K_{U}) of the user (U) 34. In the second form (2), the public key portion of the anonymity key kᵤ for the user (U) 34 is used to indicate the identity of the user associated with the enrollments (E) instead of U. As discussed, only the consuming organization (O) 26 and the user (U) 34 know that the user (U) 34 identity U is associated with the pseudonym anonymity key kᵤ/jᵤ. After building the encrypted enrollments in either format (1) or (2), the consuming organization (O) 26 or its agent (Aₒ) 24 send (at block 104) the encrypted enrollments to the user (U) 34. If the user (U) 34 and the consuming organization (O) 26 or its agent 24 are in communication via a network, such as the Internet, then the encrypted enrollments may be transmitted over such network. Alternatively, the encrypted enrollments may be encoded in a smart card and provided to the user (U) 34.

Upon receiving the encrypted enrollments (at block 106), the user (U) 34 would decrypt the message using the private key of U (J_{U}), to obtain the enrollments encrypted with the consuming organization's 26 private key J_{O}, [U E]^{O}. In this way, no one else but the user (U) 34 may decrypt the enrollments (E) and the user (U) 34 knows that the enrollments are intended for the user (U) 34 because they were encrypted with the user's 34 public key (K_{U}). The user (U) 34 can further decipher the enrollments for inspection, but cannot counterfeit them because they are signed by the consuming organization (O) 26, i.e., encrypted under the consuming organization's 26 private key J_{O}.

To obtain the resource (R) for which the user (U) 34 is entitled to obtain according to the service agreement negotiated between the consuming organization (O) 26 and the producing organization (P), in the embodiment of FIGS. 5a, b, the user (U) 34 proceeds to obtain the tickets (t) needed to access the resource from the clearance center (C) 32. At block 108, the user (U) 34 encrypts the already encrypted enrollments (U E) with the user's private key of (J_{U}). The user (U) 34 then encrypts the user (U) 34 identity information (U) and the twice encrypted enrollment (E) with the public key of the clearance center (C) 32 (K_{C}), to produce encrypted message (3) below.

(U [U E]^{O}]^{U})^{C} (3)

The user (U) 34 then transmits message (3) to the clearance center (C) 32. Upon receiving the message (at block 120), the clearance center (C) 32 decrypts (at block 122) the message with its own private key (J_{C}), thereby assuring itself that message (3) is intended for the clearance center (C) 32. In preferred embodiments, the clearance center (C) 32 has a map of user identities (U) to user public keys (K_{U}). Upon decrypting the message with its private key (J_{Y}), the clearance center (C) 32 learns of the identity U of the user (U) 34 and based thereon may select the user's 34 public key K_{U} to decrypt (at block 122) and obtain the enrollments (E) and user identity U encrypted by the private key J_{O} of the consuming organization (O) 26. The clearance center (C) 32 would then use (at block 122) the public key K_{O} of the consuming organization (O) 26 to open the final encrypted component of the message to learn of the enrollments (E) and user (U) 34 identity U associated therewith. The clearance center (C) 32 could then authenticate the identity of the sender of message (3) by comparing the user identity U encrypted with the consuming organization (O) 26 private key J_{O} with the user identity used to determine the user public key K_{U} to use to make sure that the user encrypting the enrollments with the user private key J_{U} is the same user associated with the separately encrypted enrollments (E).

The clearance center (C) 32 then maps (at block 124) the enrollment (E) in the encrypted message to a set of tickets T, which determine the access rights to resources (R) 22. The clearance center encrypts (at block 126) the tickets (t) twice, first with the private key J_{C} of the clearance center (C) 32 and, second, with the public key K_{U} of the user (U) 34, and sends this encrypted key to the user (U) 34. Upon receiving the encrypted tickets t (at block 140), the user (U) 34 decrypts (at block 142) the message with the private key J_{U} of the user (U) 34 to get the tickets encrypted with the clearance center's 34 private key J_{C}. The user (U) 34 then builds (at block 144) and sends (at block 146) encrypted message (4) including the encrypted tickets (t):

(R) z U [t]^{U})^{S} (4)

Message (4) includes a request for resources R including parameters Z. The user (U) 34 encrypts the tickets (t) with the user's 34 private key J_{U}, and then encrypts the entire message with the server's 20 public key K_{S}. The user (U) 34 then transmits (at block 146) message (4) to the server (S) 20 to access the requested resource R having parameters z.

Upon receiving the message from the user (U) 34 (at block 160 in FIG. 5b), the server (S) 20 decrypts the message (at block 162) with its private key Jₛ and determines the user's 34 identity U, which the server (S) 20 uses to access the corresponding public key K_{U} associated with identity U, leaving the tickets t encrypted with the clearance center's (C) 32 private key J_{C}. By decrypting the message using its private key Jₛ, the server (S) 20 can be assured the message is intended for the server (S) 20 and by using the public key of the user (U) 34 K_{U}, that the message came from the user (U) 34. The server (S) 20 further includes the clearance center's (C) 32 public key K_{C}, and uses this (at block 162) to decrypt the tickets t. This assures the server (S) 20 that the tickets t came from the clearance center (C) 32 and not some fraudulent entity trying to access the resource with fraudulent enrollments. The server (S) 20 then determines (at block 164) whether the tickets (t) permit access to the requested resources (R) 22. The server (S) 20 preferably includes an access control list to determine whether certain tokens, such as tickets t, allow access to certain resources (R) 22. Such an access control list is a set of permissions. Each permission is a ticket to resource mapping. If the tickets t permit access, then the server (S) 20 returns an answer (at block 166) encrypted with the user's 34 public key K_{U} granting access to the resource. If the resource is electronic data or programs, it may be provided immediately over the network. Alternatively, the resource may be shipped. Still further, the resource may be a controller which activates or executes a device, such as turn on lights, allow the user to start or access an engine or other electronic device. The user (U) 34 may return, in response to receiving the resource R or access thereto, acknowledgment after the access or use of the resource (R) 22 is complete. This response may be synchronous or asynchronous. If the tickets (t) do not provide access to the user requested resources (R) 22, then a failure code is returned (at block 168).

The embodiment of FIGS. 5a, b satisfies many of the goals of an access and authentication system for cross-organizational access. The system is scalable as new resources could be added or removed by modifying the tickets maintained by the clearance center 34. The embodiment of FIGS. 5a, b provides granularity because resources can be subdivided. This can be readily managed by adding new tickets. The serving organization P can then determine new mappings of tickets t to enrollments and tickets t to resources. The service organization (P) 30 may then update the server (S) 20 to update mappings of tickets t to resources and update the clearance center (C) 32 to provide updated mappings of enrollments (E) to tickets t. Moreover, each party is provided only the minimal amount of information needed to perform its step in the operation. If a party only needs to transmit data without having to process the data, then such data may be encrypted with a private/public key to prevent the party from ready having access to the data.

Further, each of the consuming organization (O), the producing organization (P), and the server (S) can unilaterally and asynchronously alter the user-to-resource access control mapping that it controls. Within administrator powers, these changes can be made to become effective as quickly as the situation requires.

In alternative embodiments, or with the second enrollment form (2), the user (U) 34 can guard privacy by using the anonymity key pair kᵤ/jᵤ to represent its identity in transactions. In such case, the anonymity public key kᵤ is used to represent the identity of the user (U) 34, instead of U which may contain attributes of the users 34 identity that may allow someone within the scheme to identify the user (U) 34. Further, any public/private encryption by the user would use the anonymity key pair. The consuming organization (O) 26 would maintain the identity of the user (U) 34 U for an anonymity key pair. Further, if the user (U) 34 is concerned about someone within the scheme, such as the server (S) 20, discerning the identity behind an anonymity pair by logging enrollments and activities, the user (U) 34 may frequently change the key pair by contacting the consuming organization (O) 26 or its agent 24, which would then have to provide the new anonymous public keys kᵤ to the different actors S, C, and P. Especially paranoid users could change anonymous key pairs after every resource request.

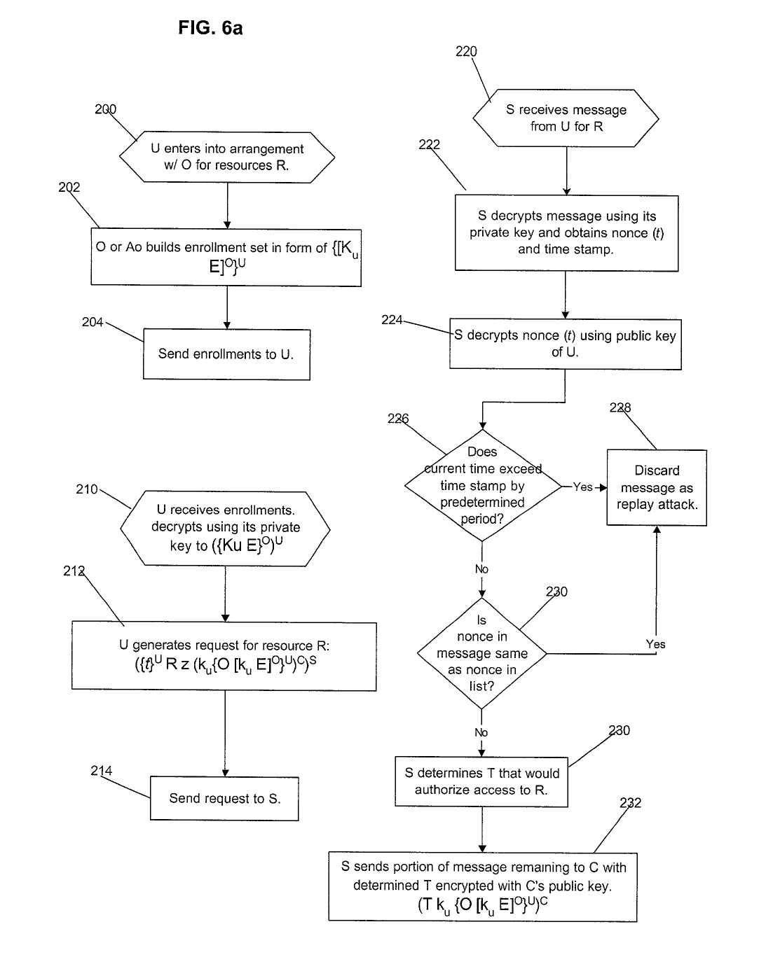

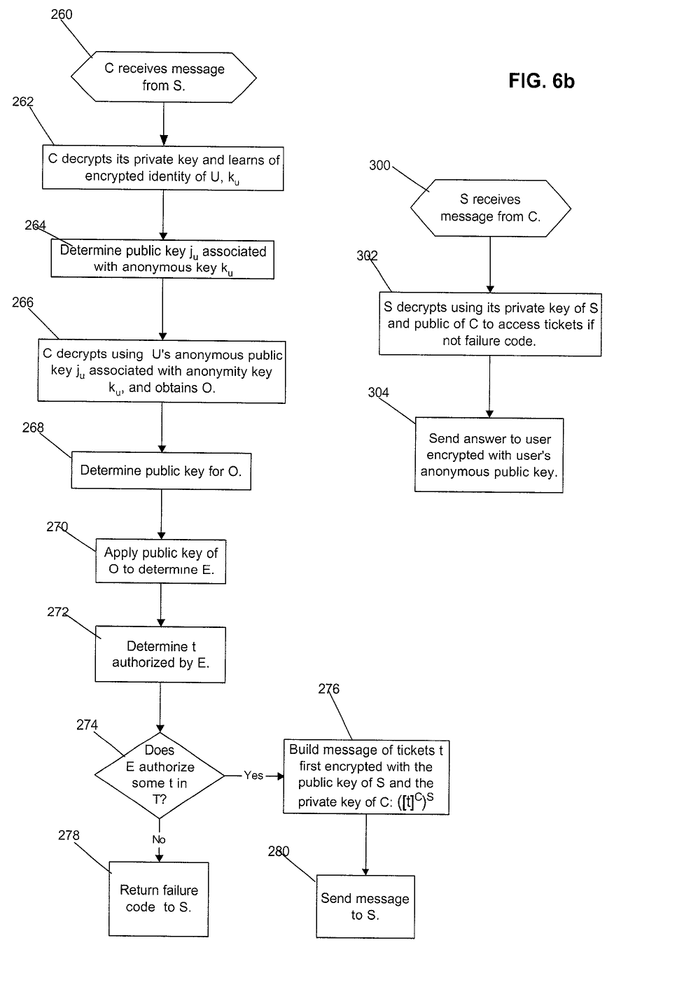

FIGS. 6a, b illustrate a further protocol to make the system immune to a replay attack, use no more messages than required, provide better privacy through the use of an anonymity key pair, and allow more powerful ticket modifiers. Further the protocol of FIG. 6 does not require the user (U) 34 to hold encrypted tickets. In this embodiment, the user (U) 34 passes enrollment (E) to the server (S) 20, which then obtains the tickets T. This is preferable because it reduces the risk that the user (U) 34 might crack the encryption on the tickets t and learn the format of the tickets (t) for fraudulent access purposes. The steps in FIG. 4 at blocks 50 to 62 would remain the same to define how the parties enter into agreements. After an agreement is reached between the user (U) 34 and the consuming organization (O) 26 or its agent 24, the consuming organization (O) 26 generates (at block 202) a message including an enrollment set in the format of form (2) above. The consuming organization (O) 26 or its agent 24 then sends (at block 204) the encrypted enrollments (E) to the user (U) 34.

Upon receiving the enrollments (at block 210), the user (U) 34 decrypts using its anonymous private key j_{U}. The user (U) 34 then encapsulates (at block 212) the encrypted enrollments (E) and anonymous identity k_{U} when building the message (5):

({τ}^{U} R z (kᵤ {O [kᵤ E]^{O}}^{U})^{C})^{S} (5)

The τ is a nonce that is a random number associated with the message used to help the server (S) 20 avoid a replay attack. The user (U) 34 encrypts the nonce with its anonymous private key kᵤ. The user (U) 34 further includes the requested resource R having parameters Z. The user (U) 34 then applies the clearing center's 32 public key K_{C} to prevent the server (S) 20 from accessing the enrollments (E), in addition to further encrypting with the user's 34 private key. The user (U) 34 then sends (at block 214) the message (5) to the server (S) 20.

Upon receiving message (5) (at block 220), the server (S) 20 decrypts (at block 122) using its private key J_{S} to determine the requested resources (R) 22 and other information outside of that portion of message (5) encrypted with the public key K_{C} of the clearance center (C) 32, including the nonce (τ) encrypted with the anonymous private key jᵤ of the user (U) 34. The server (S) 20 decrypts (at block 224) the nonce (τ) using the user anonymous public key kᵤ. The server (S) 20 then determines (at block 226) whether the current time exceeds the time stamp by a predetermined period. This predetermined period be the amount of time the server (S) 20 maintains a nonce in cache or a time within which the message (5) should have been sent. This predetermined time further incorporates clock discrepancies between the user (U) 34 and server (S) 20. If the predetermined period is exceeded, then the message (5) is discarded (at block 228) and assumed to be a replay attack as the message (5) should have be sent within the predetermined period. Otherwise, the server (S) 20 determines (at block 230) whether the nonce τ in the message matches a nonce τ in server (S) 20 cache. If so, the server (S) 20 discards (228) the message. Otherwise, the server (S) 20 determines (at block 232) a set of tickets T that would allow access to the R 22, indicated in the message. As discussed, the server (S) 20 may maintain an access control list mapping tickets t to resources.

The server (S) 20 then encrypts (at block 234) the determined set T of tickets t that would allow access to the resources (R) 22 with the public key K_{C} of the clearance center (C) 32 and the anonymous public key kᵤ of the user (U) 34 and attaches this to the remaining portion of the message (5), which is message (6) below. This new message (6) is sent to the clearance center (C) 32.

(kᵤ {O T [kᵤ E]^{O}}^{U})^{C} (6)

In this way, the server (S) 20 cannot readily determine the actual enrollments (E) as they are encrypted. This reduces the ability of the server (S) 20 to learn of the enrollments (E) format and use them in a fraudulent manner.

Upon receiving the message (6) from the server (S) 20 (at block 260), the clearance center (C) 32 decrypts (at block 262) the message (6) with its private key J_{C} and determines the portion of the message encrypted with the user's anonymity key k_{U}. The clearance center (C) 32 then uses (at block 264) the public key k_{U} associated with the anonymous public key kᵤ/jᵤ. (Since kᵤ/jᵤ were provided by the (agent of) the consuming organization, this confirms that the unknown user (U) was in fact entitled to the enrollments proffered). The clearance center (C) 32 decrypts (at block 266) the message further using the determined user public key k_{U}, and then determines the identifier (O) for the consuming organization 20 and the set T of tickets t that can access the resources (R) 22. The clearance center (C) 32 then determines (at block 268) the public key K_{O} for the consuming organization 20 based on the identity of the consuming organization, which it was previously provided, and applies (at block 270) this public key K_{O} to the message to determine the enrollments (E). The clearance center (C) 32 then examines its control lists which provide mappings of enrollments (E) to tickets to determine (at block 272) the tickets (t) mapped to the enrollment (E). The clearance center (C) 32 then determines (at block 274) whether the enrollment (E) included in the message (6) authorizes some tickets t in the set T provided with the message (6). If so, the clearance center (C) 32 builds (at block 276) message (7) below.

(t [t]^{C})^{S} (7)

The clearance center (C) 32 encrypts the tickets t in message (7) with the public key K_{S} of the server (S) 20 and the private key J_{C} of the clearance center. The clearance center then sends (280) the message (7) to the server (S) 20. If the clearance center (C) 32 determined that the enrollment (E) did not authorize any tickets t in set T, then a failure is returned (at block 278) to the server (S) 20, encrypted with the public key K_{S} of the server (S) 20. The server (S) 20, at blocks 300 to 304 would decrypt the message using its private key J_{S} and perhaps the public key K_{C} of the clearance center if tickets t are returned. If tickets are provided, then the sever (at block 304) returns an answer indicating that access to the requested resources (R) 22 is granted.

The protocols of FIGS. 6a, b insure that actors, particularly the user (U) 34 and server (S) 20, are provided with the minimal amount of information needed to determine whether to authorize and permit access to a resource. Further, the protocols minimize opportunities for fraud. For instance, the enrollments in FIGS. 6a, b are encrypted with the consuming organization's 26 private key J_{O}. This limits the opportunity for the user (U) 34 to fraudulent modify the enrollments because the server (S) 20 uses the consuming organization's (O) 26 public key K_{O} to decrypt the enrollments (E) and would not accept enrollments (E) not encrypted with the private key J_{O}. Because the clearance center (C) 32 use the consuming organization's (O) 26's public key K_{O} to open the enrollments (E), the clearance center (C) 32 is reasonably assured that the enrollments (E) came from the consuming organization (O) 26 because the consuming organization (O) 26 is likely the only holder of the private key J_{O}. The signing under the consuming organization's 26 private key J_{O} permits anyone to examine the enrollments (E), but not to alter the enrollments (E) in a way that is not easily detected. Further, because the enrollments are encrypted under the public of the clearance center (C) 32, the server (S) 20 cannot ascertain the enrollments (E) and the organization that issued them, further protecting the privacy of the user.

Moreover, the user (U) 34 is never provided the tickets (t) needed to access the resources, thus severely restricting the ability of the user (U) 34 to decode the tickets and use to fraudulently access the resources (R) 22. Instead, the tickets flow between the server (S) 20 and clearance center (C) 32 alone. The logic of FIGS. 6a, b further provides encrypted nonces to prevent replay attacks where a third party captures the message and resends to access the resources (R) 22.

The protocols of FIGS. 6a, b, like FIGS. 5a, b, provide granularity because changed levels of user access may be specified by merely adding or removing enrollments (the consuming organization (O) 26 can do this, and no-one else can), adding or removing enrollment-to-ticket mappings (only the service organization (P) 30 or the clearance center (C) 32 can do this), or adding or removing permissions (ticket-to-resource mappings, which only the server (S) 20 can perform). Further, privacy is enhanced even further with the logic of FIGS. 6a, b, because the anonymous key pair kᵤ/jᵤ is used to identify the user (U) 34.

### Safe Dealing Between Participants

The above described access and authorization scheme of FIGS. 5a, b and 6a, b assumed that the participants, such as the user (U) 34, service organization (P) 30, consuming organization (O) 26, clearance center (C) 32, and server (S) 20, have the public keys K_{U}, K_{P}, K_{O}, K_{C}, and K_{S} of the other participants. In the prior art, public keys can be obtained from a public key authority, where the public keys are certified as bound to an identity. However, as discussed, tricking administrators to include a fraudulent association of a public key and a personal identity is not difficult. For instance, a person can fraudulently obtain a public key from a certified authority that is certified as bound to an identity of an end user (U) 34 and use such key to fraudulently access the enrollments (E) of the user (U) 34.

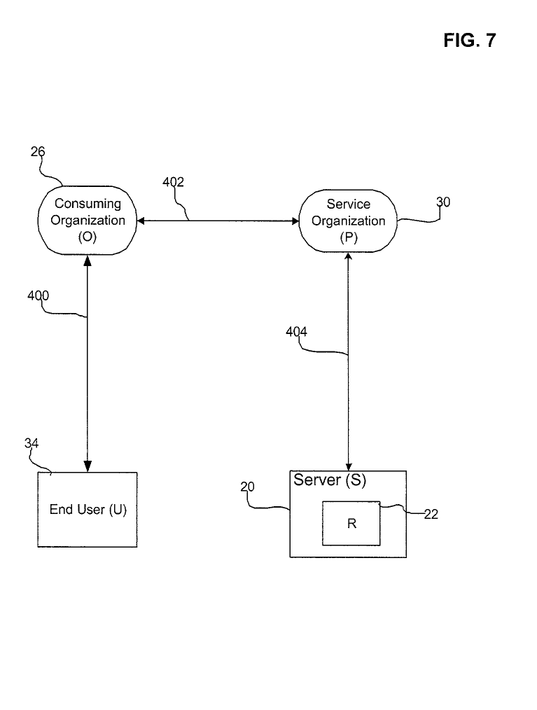

The above problem is addressed in certain of the described implementations by taking advantage of preexisting relationships between the four participants in which the identity of the participants in the relationships has been previously verified as part of the relationship with a sufficient degree of certainty. FIG. 7 illustrates three pairs of preexisting relationships 400, 402, and 404. Relationship 400 represents the preexisting dealings between the end user (U) 34 and the consuming organization (O) 26, or its administrator (A_{O}) 24. The above model assumes that the end user (U) 34 engages in ongoing transactions with the consuming organization (O) 26 or its administrator 24 where such relationship is trusted in that the consuming organization (O) 26 and end user (U) 34 have previously verified the other's identity during transactions pursuant to the relationship 400, or the end user (U) 34 shows sufficient credentials (such as a birth certificate) to the agent 23 of the organization 26 as part of a multi-purpose transaction to establish relationships (such as a student enrolling at a university registrar's office and paying semester fees that establish enrollment for many different university services). This degree of certainty of the authenticity of the identities is substantially greater than the degree of certainty guaranteed by a certificate authority. For instance, the end user (U) 34 may be a member of an organization managed by the consuming organization (O) 26 where the consuming organization (O) 26 has previously authenticated the identity of the end user (U) 34 with strong information, such as a social security number, home address, etc. In fact, the administrator 24 may have an alternative secure means of verifying the identity of the end user (U) 34 as part of their ongoing relationship.

The second preexisting relationship 402 is between the consuming organization (O) 26 or its agent (A_{O}) 24 and the service organization (P) 30 or its agent (A_{P}) 28. As discussed, the consuming organization (O) 26 and service organization (P) 30 establish a relationship 402 whereby members of the service organization (P) 30, including the end users (U) 34, can access the resources (R) 22 made available by the service organization (P) 30 through the clearance center (C) 32 and server 30. Thus, the consuming organization (O) 26 and service organization (P) 30 have a preexisting relationship concerning their transactions to provide the resources (R) 22 to the members of the consuming organization (O) 26. Again, as with the case of relationship 400, the consuming organization (O) 26 and service organization (P) 30 have used alternative verification techniques to assure themselves as to the authenticity of the identity asserted by the other as part of their ongoing relationship 402.

The third preexisting relationship 404 is between the service organization (P) 30 or its agent (A_{P}) 28 and the server (S) 20. For instance, as part of relationship 404, the server (S) 20 may have agreed to provide resources 22 to those authorized by the service organization (P) 30. Again, as with the case of relationships 400 and 402, the server (S) 20 and service organization (P) 30 have used alternative verification techniques to assure themselves as to the authenticity of the identity asserted by the other.

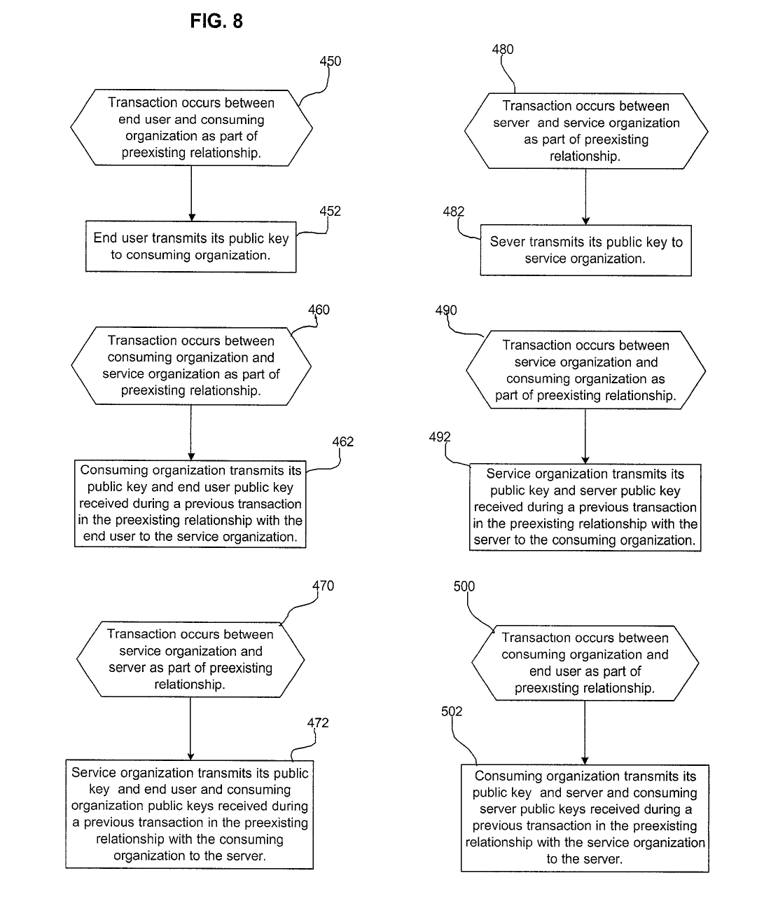

FIG. 8 illustrates a method to transfer public keys K_{U}, K_{O}, K_{P}, and K_{S} among the end user (U) 34, consuming organization (O) 26 (or its administrator A_{O} 24), service organization (P) 30 (or its administrator A_{P} 28), and the server (S) 20. Each of the parties can be assured that the public keys of the other participants in the scheme are authenticated with a reasonable degree of certainty through preexisting relationships the other parties have with each other.

With respect to FIG. 8, control begins at block 450 with a transaction occurring between the end user (U) 34 and the consuming organization (O) 26 as part of preexisting relationship 400 through which each are assured of the identity of the other. During such transaction, the end user (U) 34 transmits (at block 452) its public key K_{U} to the consuming organization (O) 26 through some secure channel, such as providing a computer diskette including the public key K_{U} or through an encrypted e-mail message encrypted using the consuming organization public key K_{O}. The consuming organization (O) 26 and end user (U) 34 may have exchanged public keys K_{U}, K_{O} subject to the preexisting relationship 400 such that both are ensured that the public key is from the other participant of relationship 400.

At block 460, a transaction occurs between the consuming organization (O) 26 and the service organization (P) 30 as part of preexisting relationship 402 through which each are assured of the authenticity of the identity of the other. During such transaction, the consuming organization (O) 26 transmits (at block 462) 400 to the service organization (P) 30 through some secure channel its public key K_{O} and the end user (U) 34 public key K_{U} received during a previous transaction pursuant to the preexisting relationship. As mentioned, the secure channel may comprise providing a computer diskette including the keys or through an encrypted e-mail message encrypted using the service organization public key K_{S}.

At block 470, a transaction occurs between the service organization (P) 30 and server (S) 20 as part of preexisting relationship 404 through which each are assured of the authenticity of the identity of the other. During such transaction, the service organization (P) 30 transmits (at block 472) its public key K_{S} and the end user (U) 34 and consuming organization (O) 26 public keys K_{U}, K_{O} to the server 30. The service organization (P) 30 would have received the public keys K_{U}, K_{O} during a previous transaction with the consuming organization (O) 26 pursuant to the relationship 402.

At block 480, a transaction occurs between the server (S) 20 and the service organization (P) 30 as part of preexisting relationship 404 through which each are assured of the identity of the other. During such transaction, the server (S) 20 transmits (at block 482) its public key K_{S} to the service organization (P) 30 through some secure channel.

At block 490, a transaction occurs between the consuming organization (O) 26 and the service organization (P) 30 as part of preexisting relationship 402 through which each are assured of the authenticity of the identity of the other. During such transaction, the service organization (P) 30 transmits (at block 492) to the consuming organization (O) 26 its public key K_{P} and the server (S) 20 public key K_{S} received during a previous transaction pursuant to the preexisting relationship 404 through some secure channel.

At block 500, a transaction occurs between the consuming organization (O) 26 and end user (U) 34 as part of preexisting relationship 400 through which each are assured of the authenticity of the identity of the other. During such transaction, the consuming organization (O) 26 transmits (at block 492) its public key K_{O} and the server (S) 20 and service organization (P) 30 public keys K_{S}, K_{P} to the end user (U) 34. The consuming organization (O) 26 would have received the public keys K_{S}, K_{P} during a previous transaction with the consuming organization (O) 30 pursuant to the relationship 402.

In implementations involving the clearance center (C) 32, an additional layer of an exchange of public keys between the server (S) 20 and clearance center (C) 32 and clearance center and service organization (P) 30 would be included in the methodology.

With the above methodology for exchanging public keys, each participant, e.g., end user (U) 34, consuming organization (O) 26, service organization (P) 30, clearance center (C) 32, and server (S) 20, receive the public keys of each other participant with a strong level of assurance that the public keys are associated with the identity of the other participants. The participants are assured that the public key they are receiving from participants with which they have no direct relationship has an authenticity commensurate with the authenticity provided through their relationship 400, 402, 404 with one other participant. For instance, the end user (U) 34 through its relationship 400 with the consuming organization (O) 26 can be assured that a public key K_{O} received from the consuming organization (O) 26 via a secure channel has a degree of authenticity comparable with the authenticity in relationship 400 because the end user (U) 34 can assume that the consuming organization (O) 26 would exercise similar discretion in its relationship 402 with the service organization (P) 30. In this way, public keys K_{P}, K_{S} received from the service organization (P) 30 would be similarly authenticated and verifiable. The methodology for exchanging public keys described with respect to FIGS. 7 and 8 provide a secure method for parties to obtain public keys from other participants in the access and authorization scheme described with respect to FIGS. 5a, b and 6a, b which utilize public keys of the participants in the scheme.

### Alternative Embodiments and Conclusions

This concludes the description of the preferred embodiments of the invention. The following describes some alternative embodiments for accomplishing the present invention.

The preferred embodiments may be implemented as a method, apparatus or article of manufacture using standard programming and/or engineering techniques to produce software, firmware, hardware, or any combination thereof. The term “article of manufacture” (or alternatively, “computer program product”) as used herein is intended to encompass one or more computer programs and data files accessible from one or more computer-readable devices, carriers, or media, such as a magnetic storage media, “floppy disk,” CD-ROM, a file server providing access to the programs via a network transmission line, holographic unit, etc. Of course, those skilled in the art will recognize many modifications may be made to this configuration without departing from the scope of the present invention.

Preferred embodiments described specific protocols and levels of encryption. However alternative levels of encryption may be used depending on the value of the information being transmitted in messages. Encryption may be relaxed for certain transactions and increased for others. Further, encryption schemes other than the private/public key method may be used.

In further embodiments the user could pass multiple enrollments at a time to access multiple resources (R) 22. Moreover, the clearance center 22 may act as the clearance center for numerous servers 20.

In preferred embodiments, the tickets and enrollments are represented as digital data, and may be embodied in a magnetic storage medium, a string of numbers or characters, marks on paper, such as a bar code or electronic media.

Preferred embodiments were described as the consumer O and producer P organizations as different entities. In alternative embodiments the consumer O and producer P may be the same organization, thereby providing for applications of the preferred embodiments to situations where there is a common point of authority. Further, even if the consumer O and producer P organizations are distinct, they may agree upon a single agent to act as a common authority or trusted broker.

Preferred embodiments were described with respect to the server being an entity that the user deals with directly. However, in further embodiment, the server may be a device. For instance, the preferred authorization techniques may be used to authorize a user to control machinery, such as a piece of heavy equipment or military hardware, at the situs of the equipment the user is attempting to control.

Preferred embodiments may be implemented with smart card technology. In such case, the encrypted enrollments and tickets are encoded in persistent memory on the smart card. When the user wants to access a resource, the server would read the persistent memory on the smart card and transmit the encrypted information to the clearance center to resolve the tickets. Preferably, even with smart cards, the enrollments and identity of the user may remain encrypted to preserve privacy and anonymity.

In further embodiments, each user may be associated with and obtain enrollment certificates from a multiplicity of organizations. Similarly, the server, service organization, and clearance center may obtain enrollment certificates from several organizations.

In further embodiments, enrollment modifiers may be used to place limitations on enrollments, such as an expiration date, dollar value limits, or any other condition clearance centers can test. Tickets may have associated modifiers which convey limitations on their deliveries. A modifier may be implemented as a predicate function of constants and variables. Modifiers may be evaluated at any time during the access process, such as during the servers final decision to grant access to the resource R. Other modifiers known in the art may also be used to limit use of an element, e.g., enrollment, ticket, etc., in the system.

In the described implementations of FIGS. 8 and 9, the parties exchanged public keys using computer diskettes or secure e-mail. However, alternative secure techniques can be used by the parties to exchange keys, whether or not such exchange occurs as part of a transaction related to the preexisting relationships 400, 402, 404 or some unrelated exchange.

In the described implementations of FIGS. 8 and 9, each participant in the scheme has a relationship with one other participant. Additionally, participants may have multiple relationships with multiple participants in the schema thereby providing alternative channels through which the public keys may be transferred.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for managing access to resources, comprising:
exchanging encryption keys among a first entity, second entity, third entity, and a fourth entity, wherein each entity has one relationship with one other entity, and wherein the encryption keys are exchanged pursuant to the relationships; and
encrypting with the encryption keys electronic messages concerning digital enrollments to provide to the first entity, wherein the digital enrollment is associated with at least one digital ticket that authorizes access to a resource managed by the fourth entity, wherein presentation of the digital enrollment causes the presentation of one digital ticket associated with the digital enrollment to authorize the first entity to access the resource.

2. The method of claim 1, wherein the first entity and the second entity have a first relationship such that the first entity is associated with the second entity and wherein the second entity and third entity have a second relationship through which entities associated with the second entity can access resources managed by the fourth entity.

3. The method of claim 2, wherein the third entity and fourth entity have a third relationship through which the fourth entity makes managed resources available to entities designated by the third entity.

4. The method of claim 3, wherein exchanging the encryption keys further comprises:
transmitting, with the fourth entity, the fourth entity encryption key to the third entity;
transmitting, with the third entity, the third entity and fourth entity encryption keys to the second entity after receiving the fourth entity encryption key from the fourth entity; and
transmitting, with the second entity, the second entity, third entity, and fourth entity encryption keys to the first entity after receiving the third entity and fourth entity encryption keys from the third entity.

5. The method of claim 3, wherein exchanging the encryption keys further comprises:
transmitting, with the first entity, the first entity encryption key to the second entity;
transmitting, with the second entity, the first entity and second entity encryption keys to the third entity after receiving the fist entity encryption key from the first entity; and
transmitting, with the third entity, the first entity, second entity, and third entity encryption keys to the first entity after receiving the first and second entity encryption keys from the second entity.

6. The method of claim 1, further comprising:
using, with the second entity, the first entity encryption key received during the exchange of encryption keys to encrypt a message including at least one digital enrollment to the first entity that the first entity can use to access the resource; and
using, with the first entity, the second entity encryption key received during the exchange of encryption keys to decrypt the message received from the second entity providing the digital enrollment.

7. The method of claim 6, further comprising:
using, with the second entity, the second entity encryption key to encrypt the message including the digital enrollment before encrypting the message with the first entity encryption key.

8. The method of claim 1, further comprising:
using, with the first entity, the encryption key of the fourth entity received during the exchange of encryption keys to encrypt a message including the digital enrollment to access the resource managed by the fourth entity; and
using, with the fourth entity, the first entity encryption key received during the exchange of encryption keys to decrypt the message received from the first entity providing the digital enrollment.

9. The method of claim 1, wherein exchanging the encryption keys further comprises exchanging the encryption keys with a fifth entity, further comprising:
maintaining, with the fifth entity, a mapping of digital enrollment to associated digital tickets;
using, with the first entity, the encryption key of the fifth entity received during the exchange of encryption keys to encrypt a message including the digital enrollment to transmit to the fifth entity;
using, with the fifth entity, the first entity encryption key received during the exchange of encryption keys to decrypt the message received from the first entity providing the digital enrollment;
processing the mapping to determine the digital tickets associated with the received enrollment; and
using, with the fifth entity, the first entity encryption key received during the exchange of encryption keys to encrypt a message including the digital tickets to transmit to the first entity to use to access the resource from the fourth entity.

10. The method of claim 9, further comprising:
using, with the first entity, the encryption key of the fourth entity received during the exchange of encryption keys to encrypt a message including the digital ticket received from the fifth entity to send to the fourth entity; and
using, with the fourth entity, the first entity encryption key received during the exchange of encryption keys to decrypt the message received from the first entity providing the digital tickets;
granting, with the fourth entity, the first entity access to the resource if the digital ticket included in the decrypted message authorizes access to the resource.

11. The method of claim 1, wherein the resource consists of a resource that is a member of the set of resources comprising: data, computer programs, and control of an electromechanical machine.

12. A system for managing access to resources, comprising:
means for exchanging encryption keys among a first entity, second entity, third entity, and a fourth entity, wherein each entity has one relationship with one other entity, and wherein the encryption keys are exchanged pursuant to the relationships; and
means for encrypting with the encryption keys electronic messages concerning digital enrollments to provide to the first entity, wherein the digital enrollment is associated with at least one digital ticket that authorizes access to a resource managed by the fourth entity, wherein presentation of the digital enrollment causes the presentation of one digital ticket associated with the digital enrollment to authorize the first entity to access the resource.

13. The system of claim 12, wherein the first entity and the second entity have a first relationship such that the first entity is associated with the second entity and wherein the second entity and third entity have a second relationship through which entities associated with the second entity can access resources managed by the fourth entity.

14. The system of claim 13, wherein the third entity and fourth entity have a third relationship through which the fourth entity makes managed resources available to entities designated by the third entity.

15. The system of claim 14, wherein the means for exchanging the encryption keys further performs:
transmitting, with the fourth entity, the fourth entity encryption key to the third entity;
transmitting, with the third entity, the third entity and fourth entity encryption keys to the second entity after receiving the fourth entity encryption key from the fourth entity; and
transmitting, with the second entity, the second entity, third entity, and fourth entity encryption keys to the first entity after receiving the third entity and fourth entity encryption keys from the third entity.

16. The system of claim 14, wherein the means for exchanging the encryption keys further performs:
transmitting, with the first entity, the first entity encryption key to the second entity;
transmitting, with the second entity, the first entity and second entity encryption keys to the third entity after receiving the fist entity encryption key from the first entity; and
transmitting, with the third entity, the first entity, second entity, and third entity encryption keys to the first entity after receiving the first and second entity encryption keys from the second entity.

17. The system of claim 12, further comprising:
means for using, with the second entity, the first entity encryption key received during the exchange of encryption keys to encrypt a message including at least one digital enrollment to the first entity that the first entity can use to access the resource; and
means for using, with the first entity, the second entity encryption key received during the exchange of encryption keys to decrypt the message received from the second entity providing the digital enrollment.

18. The system of claim 17, further comprising:
means for using, with the second entity, the second entity encryption key to encrypt the message including the digital enrollment before encrypting the message with the first entity encryption key.

19. The system of claim 12, further comprising:
means for using, with the first entity, the encryption key of the fourth entity received during the exchange of encryption keys to encrypt a message including the digital enrollment to access the resource managed by the fourth entity; and
means for using, with the fourth entity, the first entity encryption key received during the exchange of encryption keys to decrypt the message received from the first entity providing the digital enrollment.

20. The system of claim 12, wherein the means for exchanging the encryption keys further performs exchanging the encryption keys with a fifth entity, further comprising:
means for maintaining, with the fifth entity, a mapping of digital enrollment to associated digital tickets;
means for using, with the first entity, the encryption key of the fifth entity received during the exchange of encryption keys to encrypt a message including the digital enrollment to transmit to the fifth entity;
means for using, with the fifth entity, the first entity encryption key received during the exchange of encryption keys to decrypt the message received from the first entity providing the digital enrollment;
means for processing the mapping to determine the digital tickets associated with the received enrollment; and
means for using, with the fifth entity, the first entity encryption key received during the exchange of encryption keys to encrypt a message including the digital tickets to transmit to the first entity to use to access the resource from the fourth entity.

21. The system of claim 20, further comprising:
means for using, with the first entity, the encryption key of the fourth entity received during the exchange of encryption keys to encrypt a message including the digital ticket received from the fifth entity to send to the fourth entity; and
means for using, with the fourth entity, the first entity encryption key received during the exchange of encryption keys to decrypt the message received from the first entity providing the digital tickets; and
means for granting, with the fourth entity, the first entity access to the resource if the digital ticket included in the decrypted message authorizes access to the resource.

22. The system of claim 12, wherein the resource consists of a resource that is a member of the set of resources comprising: data, computer programs, and control of an electromechanical machine.

23. An article of manufacture including code executed by a first entity, second entity, third entity, and fourth entity to manage access to a resource, comprising:
code executed by the first, second, third, and fourth entities to receive encryption keys of all the other entities wherein each entity has one relationship with one other entity, and wherein the encryption keys are exchanged pursuant to the relationships; and
code executed by the first entity to receive electronic messages concerning digital enrollments encrypted with the encryption keys of at least one of the first, second, and third entities, wherein the digital enrollment is associated with at least one digital ticket that authorizes access to a resource managed by the fourth entity, wherein presentation of the digital enrollment causes the presentation of one digital ticket associated with the digital enrollment to authorize the first entity to access the resource.

24. The article of manufacture of claim 23, wherein the first entity and the second entity have a first relationship such that the first entity is associated with the second entity and wherein the second entity and third entity have a second relationship through which entities associated with the second entity can access resources managed by the fourth entity.

25. The article of manufacture of claim 24, wherein the third entity and fourth entity have a third relationship through which the fourth entity makes managed resources available to entities designated by the third entity.

26. The article of manufacture of claim 23, further comprising:
code executed by the second entity to use the first entity encryption key received during the exchange of encryption keys to encrypt a message including at least one digital enrollment to the first entity that the first entity can use to access the resource; and
code executed by the first entity to use the second entity encryption key received during the exchange of encryption keys to decrypt the message received from the second entity providing the digital enrollment.

27. The article of manufacture of claim 26, further comprising:
code executed by the second entity to use the second entity encryption key to encrypt the message including the digital enrollment before encrypting the message with the first entity encryption key.

28. The article of manufacture of claim 23, further comprising:
code executed by the first entity to use the encryption key of the fourth entity received during the exchange of encryption keys to encrypt a message including the digital enrollment to access the resource managed by the fourth entity; and
code executed by the fourth entity to use the first entity encryption key received during the exchange of encryption keys to decrypt the message received from the first entity providing the digital enrollment.

29. The article of manufacture of claim 23, wherein exchanging the encryption keys further comprises exchanging the encryption keys with a fifth entity, further comprising:
code executed by the fifth entity to maintain a mapping of digital enrollments to associated digital tickets;
code executed by the first entity to use the encryption key of the fifth entity received during the exchange of encryption keys to encrypt a message including the digital enrollment to transmit to the fifth entity;
code executed by the fifth entity to use the first entity encryption key received during the exchange of encryption keys to decrypt the message received from the first entity providing the digital enrollment;
code executed by the fifth entity to process the mapping to determine the digital tickets associated with the received enrollment; and
code executed by the fifth entity to use the first entity encryption key received during the exchange of encryption keys to encrypt a message including the digital tickets to transmit to the first entity to use to access the resource from the fourth entity.

30. The article of manufacture of claim 29, further comprising:
code executed by the first entity to use the encryption key of the fourth entity received during the exchange of encryption keys to encrypt a message including the digital ticket received from the fifth entity to send to the fourth entity; and
code executed by the fourth entity to use the first entity encryption key received during the exchange of encryption keys to decrypt the message received from the first entity providing the digital tickets; and
code executed by the fourth entity to grant the first entity access to the resource if the digital ticket included in the decrypted message authorizes access to the resource.

31. The article of manufacture of claim 23, wherein the resource consists of a resource that is a member of the set of resources comprising: data, computer programs, and control of an electromechanical machine.
